(19) United States
(12) Patent Application Publication
(10) Pub. No.: US 2012/0182528 A1
(43) Pub. Date: Jul. 19, 2012

(54) DIFFUSER SCREENS

(75) Inventor: Jonathan Paul Freeman, Cambridge (GB)

(73) Assignee: BAE Systems plc, Greater London (GB)

(21) Appl. No.: 12/302,661

(22) PCT Filed: Nov. 11, 2008
(86) PCT No.: PCT/GB2008/051053

§ 371 Date: May 5, 2010

(30) Foreign Application Priority Data
Dec. 4, 2007 (EP) 07270070.1
Dec. 4, 2007 (GB) 0723678.9

(51) Int. Cl. G02B 5/02; G03B 21/14

(52) U.S. Cl. 353/38; 359/599

(57) ABSTRACT

Light 63 incident on a first screen 61 is dispersed by the optical properties of the polymer dispersed liquid crystal material associated with the first screen 61 at a given half scatter angle 64 to provide an interim diffused pupil 65, which is incident on the second screen 62. Diffused light incident on the second screen 62 is diffused by the optical properties of the polymer dispersed liquid crystal material associated with the second screen 62 by a given half scatter angle 66 to produce the diffused pupil 60. Conducting material associated with the first and second screens 61, 62 is controlled by a controller 67 to vary the half scatter angles 64 and 66 out of phase with one another, in a manner to maintain a substantially constant diffused pupil 60.

This invention relates to a diffuser screen and a method for enhancing an image, which is particularly, but not exclusively, suitable for use to enhance an image and/or mitigate speckle associated with an image.

A problem with current laser based projection apparatus is that they tend to produce speckle. Speckle is an interference pattern caused by a coherent light source, i.e. a laser, being scattered by or from a surface or within a medium, which generates interference patterns that are detected by an observer. The interference patterns can manifest themselves as a grainy pattern superimposed on an intended image. Hence speckle can reduce the resolution and quality of an image as perceived by an observer.

Some current laser based projection apparatus utilise a laser light source delivered to a projection optical arrangement via a multimode optical fibre. The transportation of light via the multimode optical fibre produces large amounts of interference and speckle in the final image. Presently, a rotating diffuser can be used within a projection apparatus, for example, between the output of the multimode optical fibre and a projection optical arrangement, to temporally average noise induced by the multimode optical fibre and hence reduce speckle in the final image as perceived by an observer.

However, a rotating diffuser introduces a potential failure mechanism for the projection apparatus as the diffuser is driven by a suitable motor. Such motors struggle to achieve an acceptable mean time between failures in certain harsh environments, for example in a military cockpit wherein the projection apparatus is expected to operate between a temperature range of −30° C. to +70° C.

According to one aspect of the invention a diffuser screen for enhancing an image includes at least two screens each being arranged to variably control the diffusion angle of incident light, wherein the screens are arranged substantially adjacent to one another such that incident light can pass through the screens and wherein the screens are arranged to be controlled such that the combined diffusion angle presented by the screens to incident light is substantially constant over time.

In this manner, an observer viewing an image passing through the diffuser screen will perceive less speckle associated with the image. Changing the light path of the image causes speckle patterns to move such that speckle is visually reduced due to the integration period of the eye and brain of an observer temporally averaging different speckle patterns over time.

A diffuser screen may include two screens, wherein one screen may be a first polymer dispersed liquid crystal screen having a polymer dispersed liquid crystal between layers of conducting material, the conducting material being supported by a substrate material and another screen may be a second polymer dispersed liquid crystal screen having a polymer dispersed liquid crystal between layers of conducting material, the conducting material being supported by a substrate material and wherein the first and second polymer dispersed liquid crystal screens may be arranged substantially co-planer to one another.

At least part of the substrate material of the first polymer dispersed liquid crystal screen may be common with at least part of the substrate material for the second polymer dispersed liquid crystal screen.

There may be at least two layers of conducting material associated with the first polymer dispersed liquid crystal screen and there may be at least two layers of conducting material associated with the second polymer dispersed liquid crystal screen, the conducting material being arranged to generate an electric field to control the orientation of liquid crystal material within each polymer dispersed liquid crystal screen.

The two layers of conducting material of the first and second polymer dispersed liquid crystal screens may be arranged to be controlled to independently vary the diffusion angle of light transmitted through the first and second polymer dispersed liquid crystal screens. In this manner, a substantially constant diffused pupil of light exits the diffuser screen.

The at least two layers of conducting material of the first and second polymer dispersed liquid crystal screens may be arranged to be controlled to vary the diffusion angle of light transmitted through the first and second polymer dispersed liquid crystal screens, wherein the variation of the diffusion angle for first and second polymer dispersed liquid crystal screens are out of phase with one another and arranged to maintain a substantially constant diffusion angle presented to light transmitted through the diffuser. In this manner, a substantially constant diffused pupil of light exits the diffuser screen.

The polymer dispersed liquid crystal material of the first polymer dispersed liquid crystal screen may be directly adjacent to its respective layers of conducting material and the polymer dispersed liquid crystal material of the second polymer dispersed liquid crystal screen may be directly adjacent to its respective layers of conduction material.

A layer of conducting material of the first polymer dispersed liquid crystal screen may be separated from a layer of conducting material of the second polymer dispersed liquid crystal screen by a separation substrate. The thickness of the separation substrate may be less than or equal to 0.5 millimetres.

A temperature control device may be used to maintain the first and second polymer dispersed liquid crystal screens within an operating temperature range.

A projection apparatus may include a diffuser screen according to the present invention.

According to a another aspect of the invention a method for enhancing an image includes passing light used to generate an image through two or more screens and varying the diffusion angle imposed by each screen on incident light and controlling the diffusion angle of each screen such that the combined diffusion angle of the screens is substantially constant over time.

The invention will now be described, by way of example only, with reference to the accompanying drawings, in which:

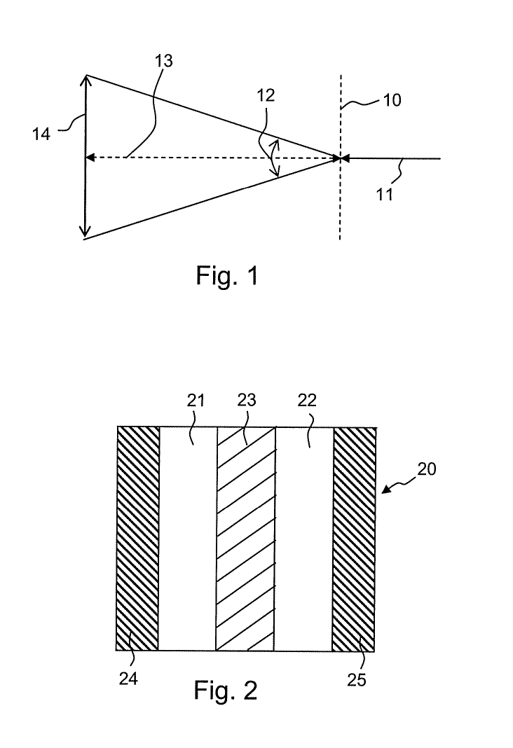

FIG. 1 is a schematic illustration of a diffuser according to the prior art;

FIG. 2 is a cross-sectional view through a polymer dispersed liquid crystal screen according to the prior art;

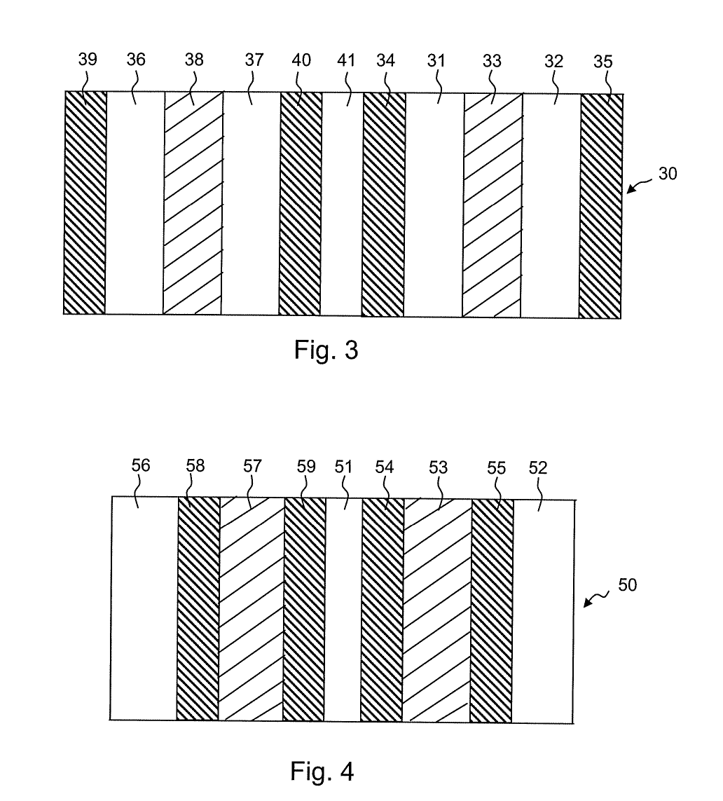

FIG. 3 is a cross-sectional view through a first embodiment of the present invention;

FIG. 4 is a cross-sectional view through a second embodiment of the present invention;

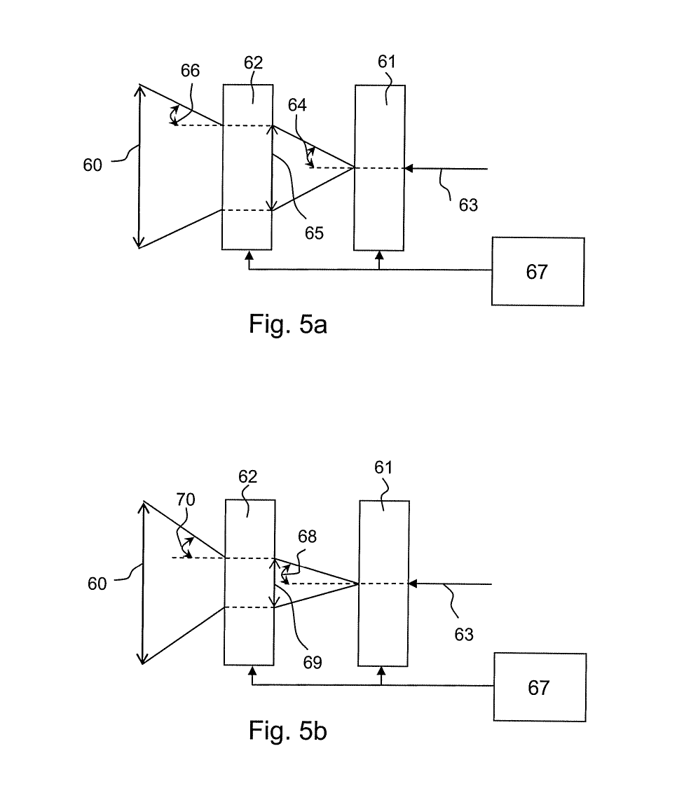

FIGS. 5a and 5b are schematic illustrations of the operation of first and second screens according to the present invention;

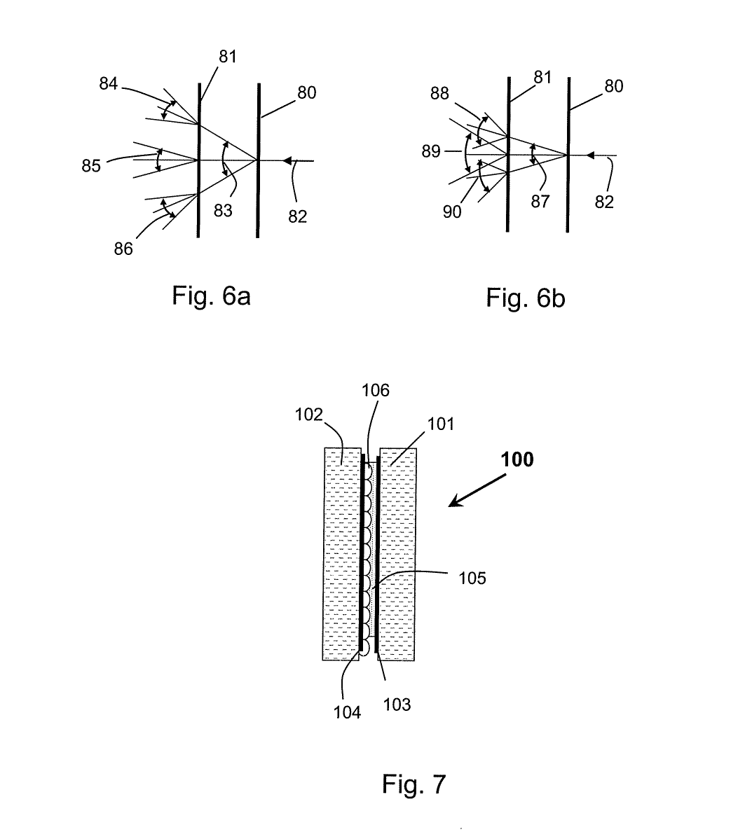

FIGS. 6a and 6b are detailed illustrations of the operation of first and second screens according to the present invention; and

FIG. 7 is a cross-sectional view through a third embodiment of the present invention.

Referring to FIG. 1, as is well known in the prior art, a diffuser 10 is a device that is arranged to spread out or scatter incident light 11 in a predefined manner. In this case incident light 11 passes through diffuser 10 and is spread by a given full scatter angle 12 to provide a predefined focal length 13 such that the diffuser 10 provides a predefined pupil 14.

Referring to FIG. 2, a polymer dispersed liquid crystal screen 20 according to the prior art comprises a first substrate 21 and a second substrate 22 arranged parallel to one another with a layer of polymer dispersed liquid crystal material 23 arranged between the first and second substrates 21, 22. The first and second substrates 21, 22 are typically formed from a clear plastic material to allow light to pass therethrough. The polymer dispersed liquid crystal material 23 is typically formed from liquid crystal droplets that are dispersed in a solid or liquid polymer matrix. Typically, the spacing between the first substrate 21 and second substrate 22 is approximately 25 micrometres.

A surface of the first substrate 21, remote from the polymer dispersed liquid crystal material 23, is arranged to carry a first conducting material 24 and, similarly, a surface of the second substrate 22, remote from the polymer dispersed liquid crystal material 23, is arranged to carry a second conductor material 25. The first and second conductor materials can be formed from Indium Tin Oxide and are optically transparent.

The first and second conducting materials 24, 25 are arranged such that when a voltage is applied to the conducting materials 24, 25 an electric field is generated between the first conducting material 24 and the second conducting material 25. By changing the orientation of the liquid crystal molecules within the electric field it is possible to vary the intensity of the light transmitted through the polymer dispersed liquid crystal screen 20.

In a typical polymer dispersed liquid crystal screen 20, there are many liquid crystal droplets with different configurations and orientations. When an electric field is applied, the molecules within the liquid crystal droplets align along the electric field and substantially all of the liquid crystal droplets have a corresponding optical property. For example, when no electric field in applied the molecules within the polymer dispersed liquid crystal material 23 will have random orientations with respect to one another. Accordingly, there is no correspondence between the refractive index properties of each liquid crystal droplet, therefore, the misaligned molecules act to reflect light from the polymer dispersed liquid crystal screen 20. However, when a voltage is applied to the first and second conducting materials, 24, 25, an electric field is generated and the molecules within each liquid crystal droplet reconfigure such that substantially all the molecules have similar refractive index properties. In this instance, the molecules align to allow transmission of light through the polymer dispersed liquid crystal screen 20.

The ability to switch the transparency of the polymer dispersed liquid crystal screen 20 lends itself to use in privacy glass where a voltage can be applied to the first and second conducting materials 24, 25 is switched off to prohibit or inhibit light passing through the polymer dispersed liquid crystal screen 20, thereby providing privacy for a person one side of the screen 20 from an observer located on the other side of the screen 20.

Referring to FIG. 3, a diffuser screen 30 according to a first embodiment of the present invention includes a first substrate 31 and a second substrate 32 parallely spaced and co-planar with respect to one another and having a polymer dispersed liquid crystal material 33 therebetween. The first substrate 31 has a planar surface remote from polymer dispersed liquid crystal material 33 arranged to carry a first conducting material 34, and similarly the second substrate 32 has a planar surface remote from polymer dispersed liquid crystal material 33 arranged to carry a second conducting material 35. The first and second substrates 31, 32 and the first and second conducting materials 34, 35 are formed from material such that they are translucent to visible light. The first and second conducting materials 34, 35 can be formed from Indium Tin Oxide.

A third substrate 36 and a fourth substrate 37 are parallely spaced and co-planar with respect to one another and have a polymer dispersed liquid crystal material 38 therebetween. The third substrate 36 has a planar surface remote from the polymer dispersed liquid crystal material 38 arranged to carry a third conducting material 39 and similarly the fourth substrate 37 has a planar surface remote from the polymer dispersed liquid crystal material 38 arranged to carry a fourth conducting material 40. Again, the third and fourth substrates 36, 37 and the third and fourth conducting materials 39, 40 are formed from a material which is translucent to visible light. The third and fourth conducting materials 39, 40 can be formed from Indium Tin Oxide.

In this embodiment, the first conducting material 34 is separated from the fourth conducting material 40 by a separation substrate 41. The separation substrate 41 is about 0.5 millimetres in thickness and is translucent to visible light.

It will be understood that conducting materials 34 and 35 and conducting materials 39 and 40 act in cooperating pairs such that when a voltage is applied across conducting materials 34 and 35 an electric field is generated that will effect the orientation of liquid crystal droplets within the polymer dispersed liquid crystal material 33 that in turn will alter the optical property of polymer dispersed liquid crystal material 33 and that similarly when a voltage is applied across conducting materials 39 and 40 a resulting electric field will alter the optical property of polymer dispersed liquid crystal material 38. In this case, the optical property is the refractive index of the polymer dispersed liquid crystal materials 33 and 38.

Referring to FIG. 4, in which a second embodiment of the invention is illustrated, a diffuser screen 50 includes a first substrate 51 and a second substrate 52 parallely spaced and co-planar with respect to one another and having a polymer dispersed liquid crystal material 53 retained therebetween. First substrate 51 has a planar surface arranged to carry a first conducting material 54 between the first substrate 51 and the polymer dispersed liquid crystal material 53. The second substrate 52 also has a planar surface arranged to carry a second conducting material 55 between the second substrate 52 and the polymer dispersed liquid crystal material 53.

The first substrate 51 and a third substrate 56 are parallely spaced and co-planar with respect to one another and have a polymer dispersed liquid crystal material 57 retained therebetween. The third substrate 56 has a planar surface arranged to carry a third conducting material 58 between the third substrate 56 and the polymer dispersed liquid crystal material 57. The first substrate 51 has a further planar surface arranged to carry a fourth conducting material 59 between the first substrate 51 and the polymer dispersed liquid crystal material 57. It should be noted that in this embodiment the first substrate 51 acts as a separator between the first conducting material 54 and the fourth conducting material 59.

The first, second and third substrates 51, 52, 53 and first, second, third and fourth conducting materials 54, 55, 58, 59 are translucent to visible light. The conducting materials 54, 55, 58, 59 can be formed from Indium Tin Oxide.

It will be understood that conducting materials 54 and 55 and conducting materials 58 and 59 act in cooperating pairs such that when a voltage is applied across conducting materials 54 and 55 an electric field is generated that will effect the orientation of liquid crystal droplets within the polymer dispersed liquid crystal material 53 that in turn will alter the optical property of polymer dispersed liquid crystal material 53 and that similarly when a voltage is applied across conducting materials 58 and 59 a resulting electric field will alter the optical property of polymer dispersed liquid crystal material 57 and that a voltage applied between conducting material 58 and 59 will alter the optical property of polymer dispersed liquid crystal material 57. In this case the optical property is the refractive index of the polymer dispersed liquid crystal materials 53 and 57.

Referring to FIGS. 5a and 5b, the first and second embodiments as described with reference to FIGS. 3 and 4 operate in a similar manner to generate a substantially constant diffused pupil 60 across a combination of a first screen 61 and a second screen 62. For the first embodiment described with reference to FIG. 3, first screen 61 schematically represents first and second substrates 31, 32, polymer dispersed liquid crystal material 33 and conducting materials 34, 35 and second screen 62 schematically represents third and fourth substrates 36, 37, polymer dispersed liquid crystal materials 38 and conducting materials 39, 40. For the second embodiment described with reference to FIG. 4, first screen 61 schematically represents first and second substrates 51, 52, polymer dispersed liquid crystal material 53 and conducting materials 54, 55 and second screen 62 schematically represents first and third substrates 51, 56, polymer dispersed liquid crystal material 57 and conducting material 58, 59.

Referring to FIG. 5a, light 63 incident on first screen 61 is dispersed by the optical properties of the polymer dispersed liquid crystal material associated with the first screen 61 at a given half scatter angle 64 to provide an interim diffused pupil 65 which is incident on the second screen 62. Diffused light incident on the second screen 62 is diffused by the optical properties of the polymer dispersed liquid crystal material associated with the second screen 62 by a given half scatter angle 66 to produce the diffused pupil 60. The conducting material associated with the first and second screens 61, 62 is controlled by a controller 67 to vary the half scatter angles 64 and 66 out of phase with one another, in a manner to maintain a substantially constant diffused pupil 60.

As can be seen in FIG. 5b, wherein like references have been used to indicate similar integers described with reference to FIG. 5a, half scatter angle 68 generated by first screen 61 generates a reduced interim diffused pupil 69. However, half scatter angle 70 generated by second screen 62 ensures that the diffused pupil 60 remains substantially constant to that achieved and described with reference to FIG. 5a.

FIGS. 6a and 6b, illustrate in detail the operation of a first screen 80 and a second screen 81 according to the invention. Like references have been used to indicate similar integers in both FIGS. 6a and 6b. FIG. 6a shows the detail of FIG. 5a. Incident light 82 is diffused by the first screen 80 to provide a cone angle 83 that spreads the light in a cone formation across the distance separating the first and second screens 80 and 81 until it strikes the second screen 81. Each ray in a cone of light as defined by cone angle 83 is then diffused further by second screen 81 into further cones of light as indicated by cone angles 84, 85 and 86. The cone angles 84, 85 and 86 are substantially similar. The overall cone angle of light produced by first and second screens 80 and 81 is a function of the size of the cone angles 83, 84, 85 and 86 of the first and second screens 80 and 81. As an approximation, the diffused pupil 60 of FIG. 5a will be determined by the size of cone angle 83 and cone angle 85, if the diffusion profile of cone angle 83 and cone angle 85 are considered to be “top hat” shaped. The diffusion cone angles 83, 84, 85 and 86 are defined by the properties of the relevant screen 80 and 81 and can be selectively altered such that the cone angles 83, 84, 85 and 86 are controlled.

FIG. 6b shows the detail of FIG. 5b, whereby modifying the properties of first and second screens 80 and 81 varies the cone angles 83, 84, 85 and 86 illustrated in FIG. 6a to give new cone angles 87, 88, 89 and 90. In this example cone angle 87 is smaller than cone angle 83 of FIG. 6a and cone angles 88, 89 and 90 are larger than cone angles 84, 85 and 86 of FIG. 6a. Similar to that described with reference to FIG. 6a, the cones 88, 89 and 90 are substantially similar.

Using an approximation of the overall cone angle calculation, the diffused pupil 60 of FIG. 5b will equal cone angle 87 plus cone angle 89 of FIG. 6b. It will be noted that cone angle 87 plus cone angle 89 will equal cone angle 83 plus cone angle 85 of FIG. 6a, which corresponds to the diffusion pupil 60 of FIG. 5a.

FIGS. 5a, 5b, 6a and 6b only illustrate a selected representation of rays and that the cones of light will contain a continual range of rays.

Referring to FIG. 7, a third embodiment of the invention includes at a first screen 100, which includes first and second transparent substrates 101 and 102 arranged co-planar with respect to one another and arranged to carry the first and second conducting materials 103 and 104. The first and second substrates 101 and 102 are arranged to retain a polymer dispersed liquid crystal material 105 therebetween. A set of lenslets 106 are arranged substantially co-planar with first and second substrates 101 and 102. The lenslets 106 have substantially the same focal lengths and are arranged within the liquid crystal material 105 such that the focal lens of the lenslets change the cone angle presented to light passing through the screen 100 when an electrical field is applied to the liquid crystal material 105 thereby altering the orientation of the molecules of the liquid crystal material. It will be understood that a second screen, not illustrated, is arranged in a similar manner to that described with reference to screen 100 and will be arranged co-planar to screen 100 to carry out the invention as described with reference to FIGS. 5a, 5b, 6a and 6b.

An advantage of using such a diffuser screen according to the invention is that although a diffuser inherently produces an image with a grainy structure the graininess is related to the numerical aperture of the illuminating light. Note the grain is not related to speckle, caused by a coherent source, as defined herein, but can be produced by an incoherent source. By having a double screen diffuser screen, grain can be produced by the first screen as it will be illuminated by a small numerical aperture, but a second screen will be illuminated by a larger numerical aperture as the first screen is arranged to increase the numerical aperture of light passing therethrough, and so should have less grain visible at its output of the diffuser screen.

Accordingly, light at the diffused pupil 60 of FIGS. 5a and 5b, which is used to form an image to be displayed to an observer is perceived by the observer to exhibit a reduced speckle content without the requirement for mechanical moving parts thereby making the apparatus less prone to failure.

Such a diffuser finds particular application in a projection apparatus for a head up or head mounted display to be used in an aircraft wherein the diffuser is arranged to reduce perceived image speckle, in particular image speckle produced by an optic fibre supplied laser source for the projection apparatus.

1-13. (canceled)

14. A diffuser screen for enhancing an image including:
at least two screens each being arranged to variably control the diffusion angle of incident light;
wherein the screens are arranged substantially adjacent to one another such that incident light can pass through the screens; and
wherein the screens are arranged to be controlled such that the combined diffusion angle presented by the screens to incident light is substantially constant over time.

15. A diffuser screen, as claimed in claim 14, including two screens, wherein one screen is a first polymer dispersed liquid crystal screen having a polymer dispersed liquid crystal between layers of conducting material, the conducting material being supported by a substrate material and another screen is a second polymer dispersed liquid crystal screen having a polymer dispersed liquid crystal between layers of conducting material, the conducting material being supported by a substrate material and wherein the first and second polymer dispersed liquid crystal screens are arranged substantially co-planar to one another.

16. A diffuser screen, as claimed in claim 15, wherein at least part of the substrate material of the first polymer dispersed liquid crystal screen is common with at least part of the substrate material for the second polymer dispersed liquid crystal screen.

17. A diffuser screen, as claimed in claim 15, wherein there are at least two layers of conducting material associated with the first polymer dispersed liquid crystal screen and there are at least two layers of conducting material associated with the second polymer dispersed liquid crystal screen, the conducting material being arranged to generate an electric field to control the orientation of liquid crystal material within each polymer dispersed liquid crystal screen.

18. A diffuser screen, as claimed in claim 17, wherein the at least two layers of conducting material of the first and second polymer dispersed liquid crystal screens are arranged to be controlled to independently vary the diffusion angle of light transmitted through the first and second polymer dispersed liquid crystal screens.

19. A diffuser screen, as claimed in claim 17, wherein the at least two layers of conducting material of the first and second polymer dispersed liquid crystal screens are arranged to be controlled to vary the diffusion angle of light transmitted through the first and second polymer dispersed liquid crystal screens, wherein the variation of the diffusion angle for first and second polymer dispersed liquid crystal screens are out of phase with one another and arranged to maintain a substantially constant diffusion angle presented to light transmitted through the diffuser.

20. A diffuser screen, as claimed in claim 15, wherein the polymer dispersed liquid crystal material of the first polymer dispersed liquid crystal screen is directly adjacent to its respective layers of conducting material and the polymer dispersed liquid crystal material of the second polymer dispersed liquid crystal screen is directly adjacent to its respective layers of conduction material.

21. A diffuser screen, as claimed in claim 20, wherein a layer of conducting material of the first polymer dispersed liquid crystal screen is separated from a layer of conducting material of the second polymer dispersed liquid crystal screen by a separation substrate.

22. A diffuser screen, as claimed in claim 21, wherein the thickness of the separation substrate is less than or equal to 0.5 millimetres.

23. A diffuser screen, as claimed in claim 15, wherein a temperature control device is used to maintain the first and second polymer dispersed liquid crystal screens within an operating temperature range.

24. A diffuser screen, as claimed in claim 15, wherein a lenslet array arrangement is arranged co-planar with the first polymer dispersed liquid crystal screen.

25. A projection apparatus including a diffuser screen as claimed in claim 14.

26. A method for enhancing an image, including:
passing light used to generate an image through two or more screens and varying the diffusion angle imposed by each screen on incident light; and
controlling the diffusion angle of each screen such that the combined diffusion angle of the screens is substantially constant over time.
